(19) United States
(12) Patent Application Publication
(10) Pub. No.: US 2026/0366953 A1
(43) Pub. Date: Nov. 19, 2026

(54) THERMAL VIBROSTRUCTURAL TEST SYSTEMS AND METHODS FOR ANALYZING MATERIALS FOR HYPERSONIC SYSTEMS

(71) Applicant: The Aerospace Corporation, El Segundo, CA (US)

(72) Inventors: Cassandra WILKERSON, Garden Grove, CA (US); Brianne Y. WILLIAMS, Albuquerque, NM (US); Allen RAINES, Farmington, UT (US); Marie RICE SASMAL, Long Beach, CA (US); Vinay K. GOYAL, Lawndale, CA (US)

(73) Assignee: The Aerospace Corporation, El Segundo, CA (US)

(21) Appl. No.: 19/209,666

(22) Filed: May 15, 2025

(51) Int. Cl. G01M 7/02

(52) U.S. Cl. CPC G01M 7/027; G01M 7/025

(57) ABSTRACT

Thermal vibrostructural test systems and methods for analyzing materials are disclosed. Ground testing is critical to identifying failure modes early, providing risk reduction in early concept design before first flight, and qualifying hardware for actual flight environments in preparation for first flight. In order to effectively simulate flight conditions, a test fixture is provided that introduces a laser heating load coupled with a static bend load and random vibration test capabilities. The test fixture simulates thermal, stress, and vibration environments that are seen by such vehicles during long duration flights at the same time.

### FIELD

The present invention generally pertains to materials testing, and more particularly, to thermal vibrostructural test systems and methods for analyzing materials for hypersonic systems.

### BACKGROUND

During hypersonic flight, flight vehicle systems experience a long duration (e.g., greater than approximately 20 minutes) of heating at high temperatures while traveling at high speeds, high mechanical stress loads, and extreme vibrational loads. These three loads act simultaneously on the structure during flight and create an extreme flight environment for the vehicle. These high temperatures (e.g., typically in a range between 800 °C to 1700 °C) depend on the speed, altitude, and flight trajectory that is flown. For hypersonic vehicles traveling for such periods of time (i.e., vehicles traveling at more than 5 times the speed of sound (Mach>5)), aerodynamic heating will cause elevated temperatures on the outer surface of a structure. Subsequent vibration loads are caused by the local acoustics induced by the turbulent boundary layer driven by pressure and velocity fluctuations in the flow as it passes around the hypersonic vehicle. Additionally, the heating environment can change the material properties of the vehicle structure, impacting the vehicle vibration characteristics. More specifically, aerodynamic heating causes changes in the properties of the materials and structures of the vehicle, such as the elastic modulus, Poisson's ratio, stiffness, and so forth. This leads to changes in the vibration characteristics such as the natural frequency and vibration mode, and can cause vibration environments and stress loads to increase on the structure. Such mechanisms can reduce reliability and lead to failure in flight. While winged structures are attractive for hypersonic vehicles to increase the lift-to-drag ratio for such long duration flights, the elevated temperatures are a particular concern such configurations, which typically experience additional vibration loads compared to configurations without wings.

Currently, testing capabilities do not exist that can effectively mimic such extreme operational conditions for combined temperature, stress, and vibration environments seen during hypersonic flight. Systems exist that combine lower temperature thermal loads (i.e., less than 800 °C) with sinusoidal vibration. However, such systems do not include a stress load or provide temperatures at relevant flight-like temperatures for rapidly traveling vehicles in atmospheric flight. Additionally, random vibration is more relevant for describing a hypersonic environment during flight. Other constraints also exist, including the lack of adequate test facilities that mimic such extreme operational environments, as well as temperature limits for testing technologies and instrumentation. Accordingly, an improved and/or alternative approach may be beneficial.

### SUMMARY

Certain embodiments of the present invention may be implemented and provide solutions to the problems and needs in the art that have not yet been fully solved by existing materials testing technologies and/or provide a useful alternative thereto. For example, some embodiments pertain to thermal vibrostructural test systems and methods for analyzing materials for hypersonic systems.

In an embodiment, a thermal vibrostructural test bed system includes a vibration test assembly using a shaker table configured to approximate vibration levels while a test article is under an applied equiaxial static stress load and thermal load. The thermal vibrostructural test bed system also includes a test fixture mounted to the shaker table. The test fixture is configured to secure a test article and provide a static bending load thereto. The thermal vibrostructural test bed system further includes one or more lasers configured to heat the test article. The thermal vibrostructural test bed system is configured to provide the static bending load, heating, and random vibration to the test article during testing.

In another embodiment, a thermal vibrostructural test bed system includes a vibration test assembly including and configured to use a shaker table to approximate vibration levels while a test article is under an applied equiaxial static stress load and thermal load. The thermal vibrostructural test bed system also includes a test fixture mounted to the shaker table. The test fixture is configured to secure the test article and provide a static bending load thereto. The thermal vibrostructural test bed system further includes a plurality of sensors operably connected to the thermal vibrostructural test bed system and one or more lasers configured to heat the test article. The one or more lasers are configured to heat the test article to 1000 °C or more. The thermal vibrostructural test bed system is configured to provide the static bending load, heating, and random vibration to the test article during testing. The plurality of sensors is configured to measure effects of the static bending load, heating, and random vibration on the test article.

In yet another embodiment, a thermal vibrostructural test bed system includes a vibration test assembly including and configured to use a shaker table to approximate vibration levels while a test article is under an applied equiaxial static stress load and thermal load. A test fixture mounted to the shaker table and including a lower portion that is mounted to the shaker table, an upper portion that is mounted to the lower portion, and a plurality of mounting points that are configured to secure the test article in place and apply a static bending load thereto. The thermal vibrostructural test bed system further includes one or more lasers configured to heat the test article. The thermal vibrostructural test bed system is configured to provide the static bending load, heating, and random vibration to the test article during testing. The one or more lasers are configured to heat the test article to 1000 °C or more.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1A is a perspective view illustrating a thermal vibrostructural test bed system, according to an embodiment of the present invention.

FIG. 1B is a side cutaway view illustrating a test fixture, according to an embodiment of the present invention.

FIGS. 2A-C illustrate a CAD model of a test article and test fixture, according to an embodiment of the present invention.

FIG. 2D is a graph illustrating random vibration loading (input acceleration time history) applied to the test article of FIGS. 2A-C, according to an embodiment of the present invention.

FIG. 2E is a graph illustrating the six components of strain responses over time at a location on the test article of FIGS. 2A-C, according to an embodiment of the present invention.

FIG. 2F is a graph illustrating acceleration power spectral density (PSD) responses over time in three dimensions for the test article of FIGS. 2A-C, according to an embodiment of the present invention.

FIG. 3 is an architectural diagram illustrating a thermal vibrostructural test bed system, according to an embodiment of the present invention.

FIG. 4 is an architectural diagram illustrating a computing system configured to facilitate thermal vibrostructural testing and analysis, according to an embodiment of the present invention.

FIGS. 5A and 5B are flowcharts illustrating processes for performing thermal vibrostructural analysis and testing, respectively, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to thermal vibrostructural test systems and methods for analyzing materials for hypersonic systems. Ground testing is still critical to identifying failure modes early, providing risk reduction in early concept design before first flight, and qualifying hardware for actual flight environments in preparation for first flight. Testing qualifies hardware for flight and ensures that the hardware is designed to tolerate flight-like environments. Testing also gives the ability to verify and validate pre-flight predictions performed by analysis. Furthermore, such testing allows for development and refining of prediction tool capabilities.

To effectively simulate such flight conditions, a test system is utilized that introduces a laser heating load coupled with a static bend load and random vibration test capabilities. Using a laser reduces the need for traditional thermal chambers, can localize the heat source to just the test article, and can reach the high temperatures experienced in hypersonic flight. The static bend load may be induced by a test fixture with any desired number of points without deviating from the scope of the invention and size capabilities of test fixtures and test articles (e.g., 2, 3, 4, etc.). Application of a pressure load through the design of the test fixture induces the static bend load by the number of points that are designed therein. The random vibration load is generated by a shaker table. The test fixture that induces the static bend load is mounted to the shaker table. This test combination simulates thermal, stress, and vibration combined environments that are representative of such vehicles during long duration flights at the same time. Testing of this unique combination of loads provides a more accurate understanding of how different load types couple during flight and allow for proper qualification of flight hardware to ensure its survivability under severe loading. Some embodiments provide relevant temperature and enthalpy conditions compared to flight, Mach number and Reynolds numbers cannot be directly matched due to similarity.

An advantage of such embodiments is that heating may be simulated without the use of a thermal vacuum chamber. Using lasers instead provides a more pointed and specific heating source. Thermal vacuum chambers are expensive, and commercially available shaker tables are not designed for operation in such environments. In other words, no specific environmental needs exist in some embodiments other than providing the components for the thermal vibrostructural test bed separately.

In some embodiments, a test article (e.g., a test coupon, a cantilever beam that simulates a wing, a portion of a vehicle structural component, etc.) is placed under a combination of static bending load, heating, and random vibration. The size and power of the shaker table may be selected according to the test article and desired acceleration amplitudes to be applied. In the case that the test article is too large to be mounted and/or sufficiently shaken using a single shaker table, multiple shaker tables may be used.

Random vibration is used to simulate the local acoustic environment that is created from a turbulent boundary layer that a hypersonic vehicle will experience. The results are then analyzed to determine material and structural performance. For instance, in some embodiments, a coupon design (e.g., a puck) may be installed as a test article within a test fixture and mounted to shaker table(s). An advantage of using a coupon is that the fundamental properties that are present in the material can be teased out and then used in subsequent finite element simulations. The test fixture applies a static bending load, inducing an axisymmetric static bend load through a desired number of points on the test article. Then, a laser induced heating load is applied to the test article design using one or more lasers to mimic desired in-flight temperatures for testing (e.g., up to 1700 °C or more). From there, a base drive random vibration loading is applied by the shaker table(s).

While it is difficult to match every hypersonic flight condition on the ground due to difficulty in matching all similarity parameters, the test concept and supporting analysis of such embodiments demonstrates an approach to couple thermal and vibration loadings while applying an equiaxial stress state to replicate a portion of the hypersonic environment. No other test facility with this capability exists, and alternative technologies are limited to separate individual testing of each load case, which is not accurate for high-speed environments, including hypersonic environments.

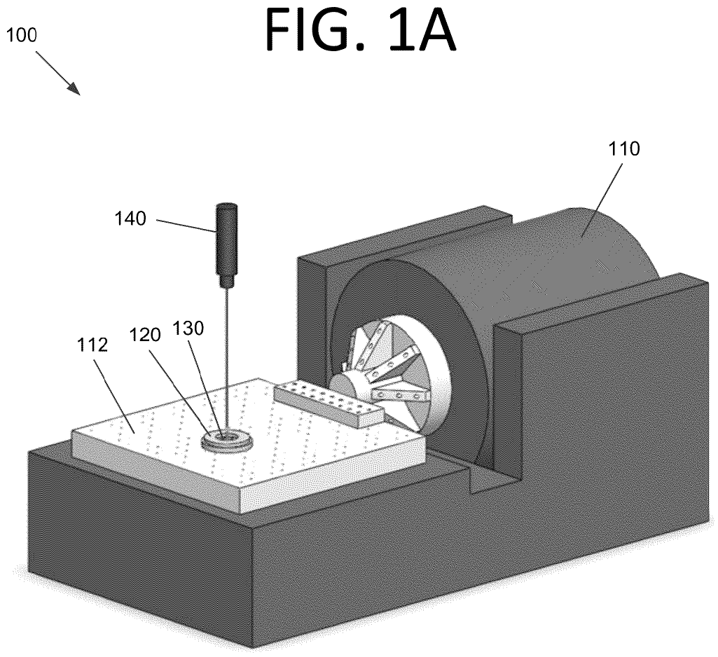

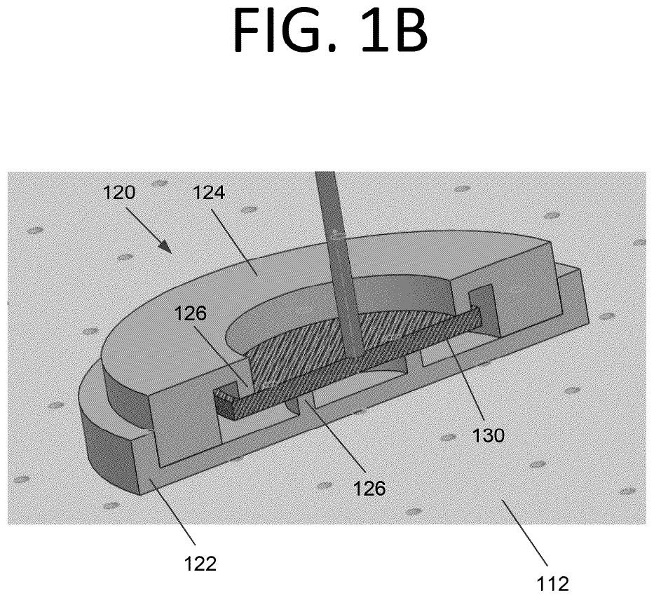

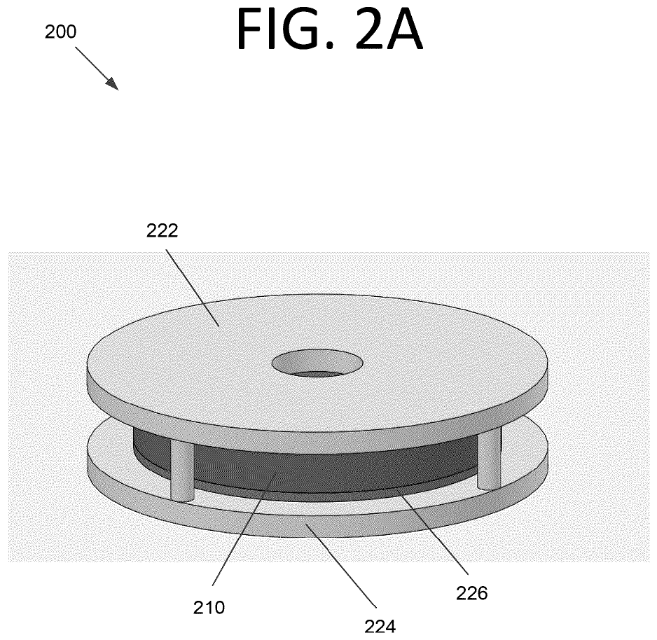

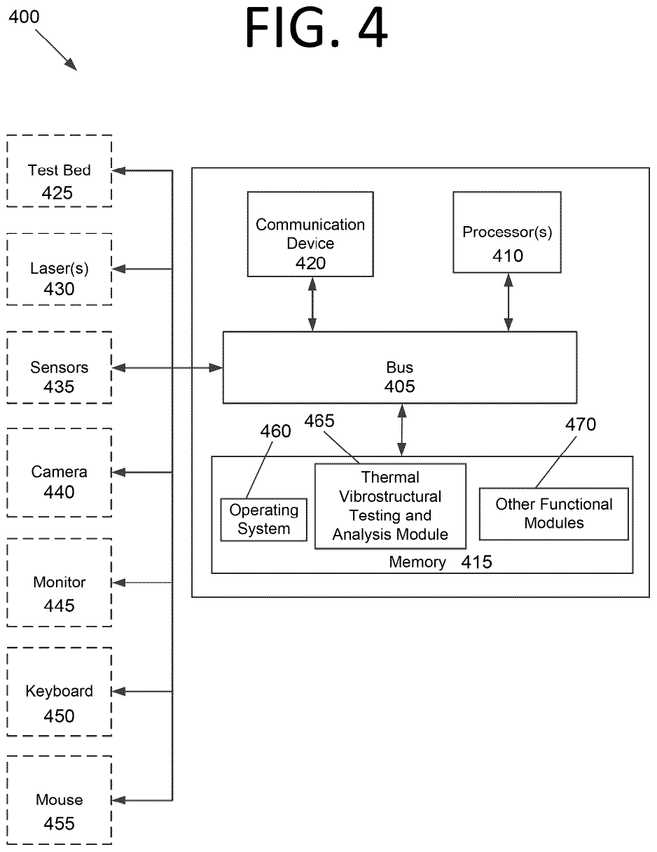

FIG. 1A is a perspective view illustrating a thermal vibrostructural test bed system 100, according to an embodiment of the present invention. Thermal vibrostructural test bed system 100 includes a vibration test assembly 110 with a shaker table 112. Shaker table assemblies are available from various manufacturers, such as Unholtz-Dickie Corp. A test fixture 120 is mounted to shaker table 112. Test fixture 120 contains and secures a test article 130. A laser 140 is used to heat test article 130 to the desired temperature. The operations of vibration test assembly 110, laser 140, and sensors (not shown) may be controlled and analyzed by a computing system, such as computing system 400 of FIG. 4.

Turning to FIG. 1B, test fixture 120 includes a lower portion 122 that is mounted to shaker table 112 and an upper portion 124 that is mounted to lower portion 122. Lower portion 122 and upper portion 124 include mounting points 126 that secure test article 130 in place. Test fixture 120 also applies a static bending load (an asymmetric static 4-point bend load in this embodiment) on test article 130 via designed ridges 126.

Base-drive random vibration loading is applied by vibration test assembly 110 via shaker table 112 to simulate specified flight levels. Strain gauges, thermocouples, and accelerometers may be used to measure the static load, thermal stress, and random vibration environments, respectively. Most sensors should be placed on the text article itself. Additional accelerometers can be placed on the test fixture to measure input acceleration to the test article. The number of sensors is dependent on desired outputs and channel quantity by the users (e.g., engineers). However, the number of sensors is limited to the surface area available on the test article for application.

Such testing can provide various information, such as whether a material is viable, failure physics, and whether a new material design is needed. Finite element models can be anchored based on the test results and outputs. This can help to test the limitations of the test article.

Typically, it is not initially known whether an initial design will survive in the desired flight environment. If and when failure occurs during testing, engineers gain valuable insights into the design and what it can withstand. A finite element model (e.g., a computer-aided design (CAD) model) is developed with starting conditions and known equations. A finite element solver such as Abaqus® can then be used that takes the CAD model, discretizes the CAD model with elements (e.g., “squares”), gives the model starting conditions, and simulates the stress by solving known equations. Requisite boundary conditions and loading profiles (i.e., pressure, thermal, and random vibration) are provided to this software. Material properties are also input (e.g., Young's modulus, the modulus of elasticity, stress, etc.). An increased amount of vibration (e.g., ±6 decibels (dB)) may be padded in to qualify the test article for the predicted flight environments that the article will experience. Based on this information, the finite element solver analyzes the model and outputs the requested thermal, stress, and vibration results. It should be noted that other results can be requested through the finite element solver as desired. It should also be noted that while turbulent air is generally random in nature, open domain data exists based on local acoustic levels that can be simulated.

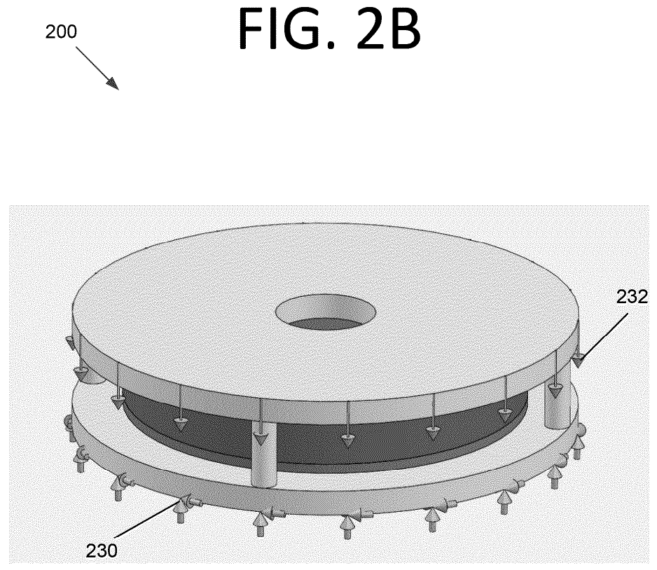

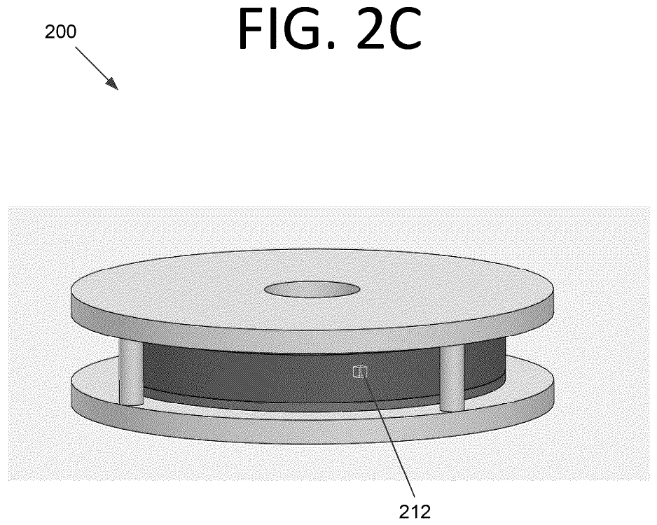

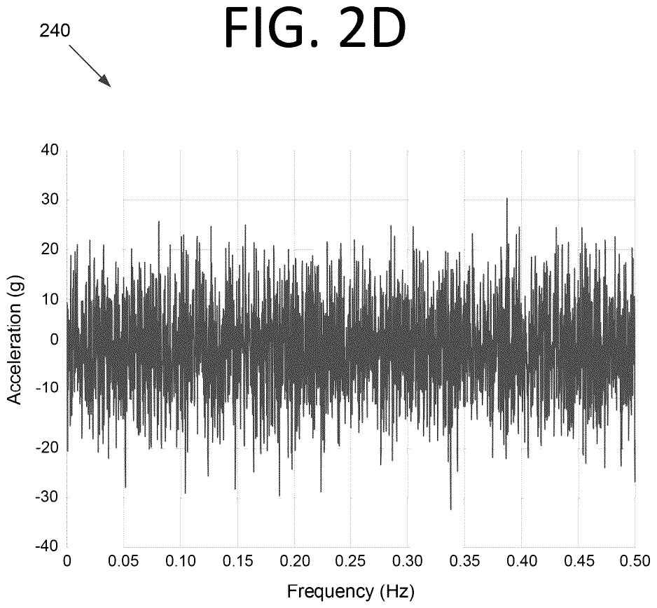

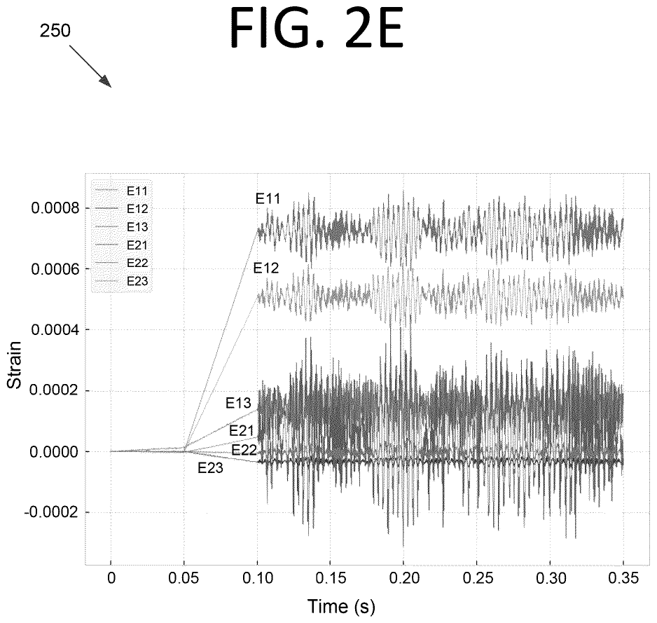

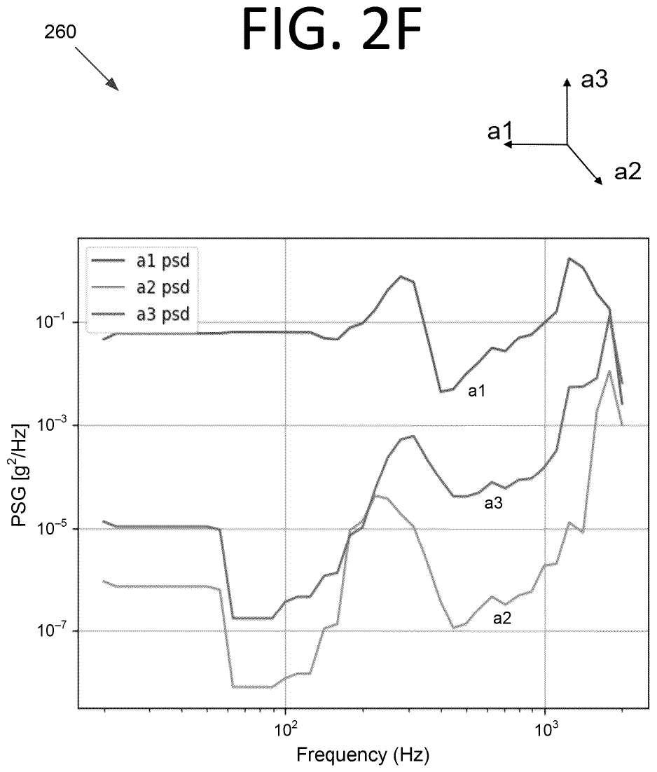

To simulate the test article and test fixture, a CAD model may be generated, per the above. FIGS. 2A-C illustrate a CAD model 200 of a test article 210 and test fixture 220, according to an embodiment of the present invention. FIGS. 2A-C are a CAD model 200 of a test article, according to an embodiment of the present invention. Test fixture 220 includes an upper portion 222, a base portion 224, and ridges 226 to induce a 4-point static bend in test article 210 while clamped. Base portion 224 of test fixture 220 is rigidly constrained to mimic mounting to a shaker table.

Thermal and dynamic loads were applied to test article 210 and test fixture 220 to demonstrate the ability to couple all three loading types at once. These loading profiles can be swapped out to align with flight-like profiles as desired. For example, the thermal load can be changed from a time variant to a spatially variant load across the puck (i.e., test article 210).

The analysis approach in some embodiments is as follows:
(1) Generate a simplified model of a test article and test fixture with general material properties. Boundary conditions should include a fixed constraint across the bottom face of the test fixture. This is shown by cones 230 on base portion 224 in FIG. 2B.
(2) Apply a constant static pressure load to the top face of top portion 222 of test fixture 220, thus inducing the static bend loading. This is shown by arrows 232 in FIG. 2B and is applied at time t=0.0 seconds(s).
(3) Apply a constant thermal load (e.g., 100 °C) to the entirety of test article 210. It should be noted that in this example, the coefficient of thermal expansion (CTE) of the arbitrary material is 1×10⁻⁵/°C. However, in practice, the actual CTE of the material would be used. For this example, the thermal load was applied at t=0.05 s.
(4) Apply a random vibration loading (see graph 240 of FIG. 2D) to the base of test article 210 in a lateral direction to mimic a base-shake test on a shaker table. This was applied at t=0.1 s in this example.
(5) Recover analytical responses specified location 212 in FIG. 2C on test article 210. Analytical responses for this demonstration included strain and acceleration time domain responses.

Graph 250 of FIG. 2E shows the analytically recovered strain responses through time at point 212, demonstrating the strain the test puck was under as different loadings were applied and showing how the puck response with each additional coupled load. The six curves depicted in FIG. 2E represent the six components of strain, where E11, E12, and E13 refer to the normal directions and E21, E22, and E23 refer to the shear directions. At 0 s to 0.05 s, test article 210 is under a static load. At 0.05 s to 0.10 s, test article 210 is under both static and thermal load. At 0.10 s to 0.35 s, test article 210 is under static, thermal, and dynamic load.

Graph 260 of FIG. 2F shows the analytically recovered vibration responses at box 212 while test article 210 was under a coupled static, thermal, and dynamic load. The depicted power spectral density (PSD) is an analytical transformation of the time-domain acceleration responses recovered from the analysis. The time-domain acceleration outputs recovered at box 212 were transformed to a PSD in the frequency-domain using scripting software and the relevant mathematical equations. The curves displayed on this plot represent the three directions of motion as shown by the axes in the upper right corner. Response a1 is the highest response because it is in the direction of loading while responses a2 and a3 are lower because they are cross-axes.

As discussed above, it is difficult to match every flight condition during hypersonic flight due to similarity parameter matching. The approach of some embodiments offers a unique way to replicate a portion of the hypersonic environment. Current alternative technologies are severely limited to separate individual testing of each load case. This is not an accurate or sufficient test for the severe loads seen in hypersonic environments. Furthermore, conventional approaches are both costly and time consuming. By introducing random vibration coupled with a thermal heat load while using an equiaxial stress state to replicate a portion of the hypersonic environment, deeper understanding of and design to hypersonic environments can be demonstrated and better designs of materials and structural entities can be achieved. This can aid in cost savings by not requiring expensive test facilities, such as vacuum chambers, and furthermore, can reduce the time it takes to test an article by performing all tests at once. Such embodiments can also be coupled with imaging analysis to look for micro-cracking, warping, plastic deformation, etc., which will help inform the structural integrity of the design.

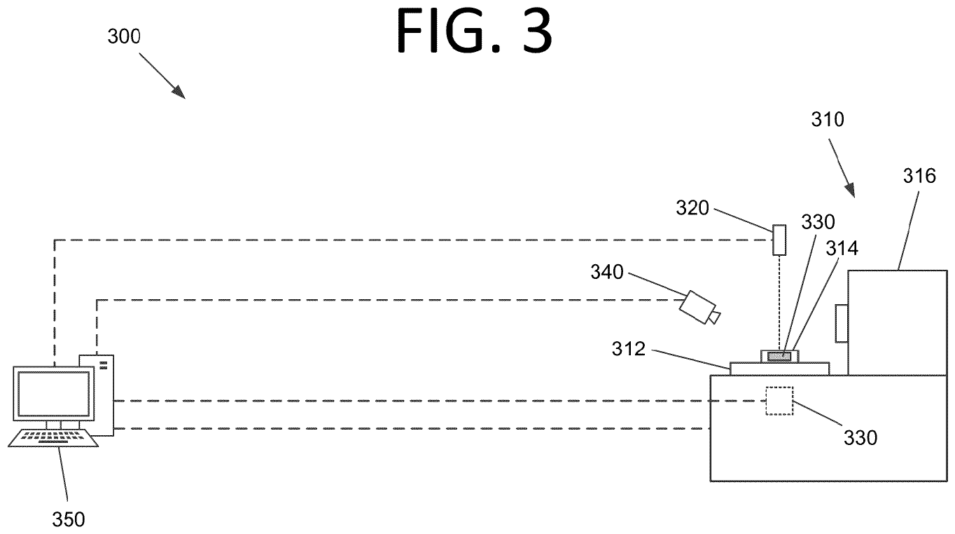

FIG. 3 is an architectural diagram illustrating a thermal vibrostructural test bed system 300, according to an embodiment of the present invention. Thermal vibrostructural test bed system 300 includes a thermal vibrostructural test bed 310 with a laser 320 that heats a test article 330. Test article is secured to a shaker table 312 by a test fixture 314. A vibration test assembly 316 is configured to cause the vibration of shaker table 312. Sensors 330 (e.g., strain gauge(s), thermocouple(s), accelerometer(s), etc.) are operably connected to thermal vibrostructural test bed 310 to measure strain, temperature, vibration, etc.

A camera 340 takes high resolution images of test article after testing. Test article 330 may need to be removed from test fixture 314 in order to do so. Camera 340 may take detailed, high-resolution images with high magnification in order to investigate micro-cracking, warping, plastic deformation, etc.

A computing system 350 (e.g., computing system 400 of FIG. 4) controls thermal vibrostructural test bed 310, laser 320, and potentially, camera 340. Computing system 350 also receives data from sensors 330 during testing. Computing system 350 may run CAD software that allows a user to design virtual models that mimic test article 330. Computing system 350 may also run a finite element solver that takes the CAD model and characteristics of the material as input to anchor the model using the test data from sensors 330.

FIG. 4 is an architectural diagram illustrating a computing system 400 configured to facilitate thermal vibrostructural testing and analysis, according to an embodiment of the present invention. Computing system 400 includes a bus 405 or other communication mechanism for communicating information, and processor(s) 410 coupled to bus 405 for processing information. Processor(s) 410 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 410 may also have multiple processing cores, and at least some of the cores may be configured to perform specific functions. Multi-parallel processing may be used in some embodiments. In certain embodiments, at least one of processor(s) 410 may be a neuromorphic circuit that includes processing elements that mimic biological neurons. In some embodiments, neuromorphic circuits may not require the typical components of a Von Neumann computing architecture.

Computing system 400 further includes a memory 415 for storing information and instructions to be executed by processor(s) 410. Memory 415 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 410 and may include volatile media, non-volatile media, or both. The media may also be removable, non-removable, or both. Computing system 400 includes a communication device 420, such as a transceiver, to provide access to a communications network via a wireless and/or wired connection. In some embodiments, communication device 420 may include one or more antennas that are singular, arrayed, phased, switched, beamforming, beamsteering, a combination thereof, and or any other antenna configuration without deviating from the scope of the invention.

Processor(s) 410 are further coupled via bus 405 to a test bed 425, laser(s) 430, sensors 435, and a camera 440. These components may be the respective components described with respect to FIGS. 1A, 1B, 2A-C, and/or 3 in some embodiments. Processor(s) 410 are further coupled via bus 405 to a display 445. Any suitable display device and haptic I/O may be used without deviating from the scope of the invention. A keyboard 450 and a cursor control device 455, such as a computer mouse, a touchpad, etc., are further coupled to bus 405 to enable a user to interface with computing system 400. However, in certain embodiments, a physical keyboard and mouse may not be present, and the user may interact with the device solely through display 425 and/or a touchpad (not shown). Any type and combination of input devices may be used as a matter of design choice. In certain embodiments, no physical input device and/or display is present. For instance, the user may interact with computing system 400 remotely via another computing system in communication therewith, or computing system 400 may operate autonomously.

Memory 415 stores software modules that provide functionality when executed by processor(s) 410. The modules include an operating system 460 for computing system 400. The modules further include a thermal vibrostructural testing and analysis module 465 that is configured to perform all or part of the processes described herein or derivatives thereof. Computing system 400 may include one or more additional functional modules 470 that include additional functionality.

One skilled in the art will appreciate that a “computing system” could be embodied as an embedded computing system, a flight computer, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or accessible by a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

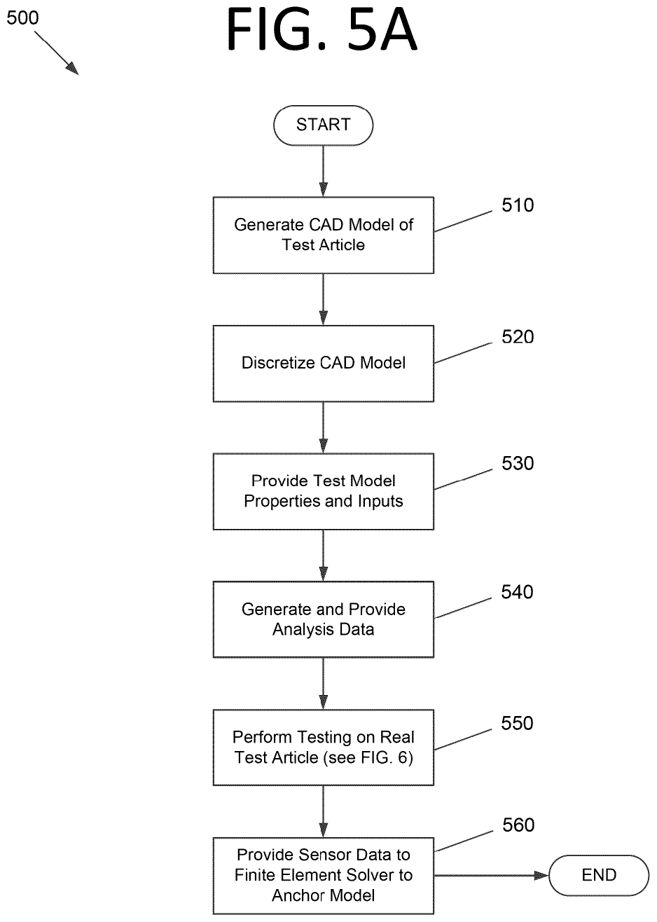

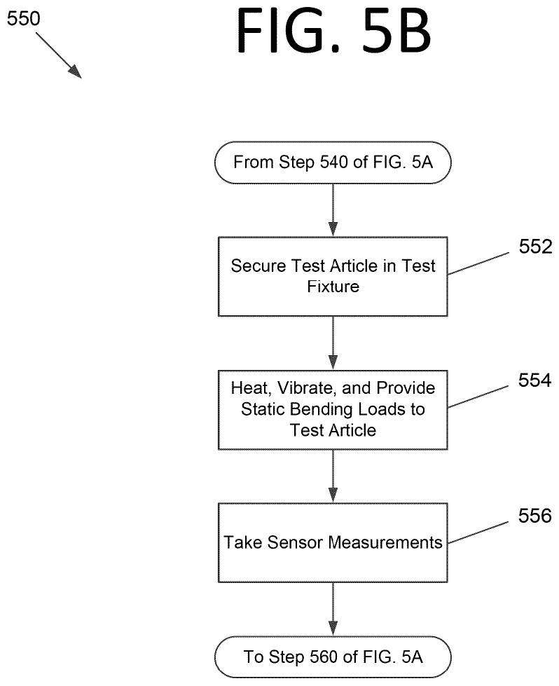

FIG. 5A is a flowchart illustrating a process 500 for performing thermal vibrostructural analysis and FIG. 5B is a flowchart illustrating a process for performing thermal vibrostructural testing 550, according to an embodiment of the present invention. The process begins with generating a CAD model of a test article at 510. The CAD model is then discretized by a finite element solver at 520. Inputs are provided to the finite element solver at 530. These inputs may include, but are not limited to, material properties of the test article, boundary conditions, pressure, temperature, and vibration loading profiles, etc. These include applying a constant 4-point bend static pressure load to the test fixture to induce static bend loading, applying a constant thermal load to the entirety of the test article, and applying the random vibration loading in the form of a base drive acceleration in some embodiments. Analytical responses will be recovered at various locations on the test article model. The finite element solver generates and provides thermal profiles, strain responses, and vibration profiles based on the analysis at 540, demonstrating an analytical representation of all three loads coupled together on the test model.

Testing is then performed on the test article at 550 using the test setup that was described previously. The testing securing the test article in the test fixture at 552 and then heating the test article with laser(s), providing random vibrations to the test article, and applying 4-point static bending loads to the test article at 554. Sensor measurements are taken during the test at 556 to measure the stresses acting on the article, including strain, temperature, and acceleration. Following the testing, the sensor information is provided to the finite element solver at 560 to anchor the analytical model.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A thermal vibrostructural test bed system, comprising:
a vibration test assembly comprising and configured to use a shaker table to approximate vibration levels while a test article is under an applied equiaxial static stress load and thermal load;
a test fixture mounted to the shaker table, the test fixture configured to secure the test article and provide a static bending load thereto; and
one or more lasers configured to heat the test article, wherein the thermal vibrostructural test bed system is configured to provide the static bending load, heating, and random vibration to the test article during testing.

2. The thermal vibrostructural test bed system of claim 1, further comprising:
a plurality of sensors operably connected to the thermal vibrostructural test bed system.

3. The thermal vibrostructural test bed system of claim 2, wherein the plurality of sensors comprise a strain gauge, a thermocouple, and an accelerometer.

4. The thermal vibrostructural test bed system of claim 1, wherein the test fixture further comprises:
a lower portion that is mounted to the shaker table;
an upper portion that is mounted to the lower portion; and
a plurality of mounting points that are configured to secure the test article in place and apply the static bending load.

5. The thermal vibrostructural test bed system of claim 1, further comprising:
a plurality of sensors operably connected to the thermal vibrostructural test bed system; and
a computing system comprising memory storing computer program instructions and at least one processor configured to execute the stored computer program instructions, the computer program instructions configured to cause the at least one processor to:
receive information comprising measurements from the plurality of sensors, a model of the test article, material properties of the test article, pressure, temperature, and vibration test assembly characteristics,
analyze the received information, and
based on the received information and the analysis, generate and provide thermal profiles, stress profiles, and vibration profiles.

6. The thermal vibrostructural test bed system of claim 5, wherein the computer program instructions are further configured to cause the at least one processor to:
pad an increased amount of vibration into the analysis to ensure that a material of the test article can survive real flight conditions.

7. The thermal vibrostructural test bed system of claim 5, further comprising:
a camera configured to take images of the test article to investigate at least one of micro-cracking, warping, plastic deformation, wherein
the computer program instructions are further configured to cause the at least one processor to:
receive images from the camera, and
display magnified versions of the received images.

8. The thermal vibrostructural test bed system of claim 1, wherein the one or more lasers are configured to heat the test article to 1000°C or more.

9. A thermal vibrostructural test bed system, comprising:
a vibration test assembly comprising and configured to use a shaker table to approximate vibration levels while a test article is under an applied equiaxial static stress load and thermal load;
a test fixture mounted to the shaker table, the test fixture configured to secure the test article and provide a static bending load thereto;
a plurality of sensors operably connected to the thermal vibrostructural test bed system; and
one or more lasers configured to heat the test article, the one or more lasers configured to heat the test article to 1000°C or more, wherein
the thermal vibrostructural test bed system is configured to provide the static bending load, heating, and random vibration to the test article during testing,
the plurality of sensors is configured to measure effects of the static bending load, heating, and random vibration on the test article.

10. The thermal vibrostructural test bed system of claim 9, wherein the plurality of sensors comprise a strain gauge, a thermocouple, and an accelerometer.

11. The thermal vibrostructural test bed system of claim 9, wherein the test fixture further comprises:
a lower portion that is mounted to the shaker table;
an upper portion that is mounted to the lower portion; and
a plurality of mounting points that are configured to secure the test article in place and apply the static bending load.

12. The thermal vibrostructural test bed system of claim 9, further comprising:
a computing system comprising memory storing computer program instructions and at least one processor configured to execute the stored computer program instructions, the computer program instructions configured to cause the at least one processor to:
receive information comprising measurements from the plurality of sensors, a model of the test article, material properties of the test article, pressure, temperature, and vibration test assembly characteristics,
analyze the received information, and
based on the received information and the analysis, generate and provide thermal profiles, stress profiles, and vibration profiles.

13. The thermal vibrostructural test bed system of claim 12, wherein the computer program instructions are further configured to cause the at least one processor to:
pad an increased amount of vibration into the analysis to ensure that a material of the test article can survive real flight conditions.

14. The thermal vibrostructural test bed system of claim 12, further comprising:
a camera configured to take images of the test article to investigate at least one of micro-cracking, warping, plastic deformation, wherein
the computer program instructions are further configured to cause the at least one processor to:
receive images from the camera, and
display magnified versions of the received images.

15. A thermal vibrostructural test bed system, comprising:
a vibration test assembly comprising and configured to use a shaker table to approximate vibration levels while a test article is under an applied equiaxial static stress load and thermal load;
a test fixture mounted to the shaker table and comprising a lower portion that is mounted to the shaker table, an upper portion that is mounted to the lower portion, and a plurality of mounting points that are configured to secure the test article in place and apply a static bending load thereto; and
one or more lasers configured to heat the test article, wherein the thermal vibrostructural test bed system is configured to provide the static bending load, heating, and random vibration to the test article during testing, and
the one or more lasers are configured to heat the test article to 1000°C or more.

16. The thermal vibrostructural test bed system of claim 15, further comprising:
a plurality of sensors operably connected to the thermal vibrostructural test bed system.

17. The thermal vibrostructural test bed system of claim 16, wherein the plurality of sensors comprise a strain gauge, a thermocouple, and an accelerometer.

18. The thermal vibrostructural test bed system of claim 15, further comprising:
a plurality of sensors operably connected to the thermal vibrostructural test bed system; and
a computing system comprising memory storing computer program instructions and at least one processor configured to execute the stored computer program instructions, the computer program instructions configured to cause the at least one processor to:
receive information comprising measurements from the plurality of sensors, a model of the test article, material properties of the test article, pressure, temperature, and vibration test assembly characteristics,
analyze the received information, and
based on the received information and the analysis, generate and provide thermal profiles, stress profiles, and vibration profiles.

19. The thermal vibrostructural test bed system of claim 18, wherein the computer program instructions are further configured to cause the at least one processor to:
pad an increased amount of vibration into the analysis to ensure that a material of the test article can survive real flight conditions.

20. The thermal vibrostructural test bed system of claim 18, further comprising:
a camera configured to take images of the test article to investigate at least one of micro-cracking, warping, plastic deformation, wherein
the computer program instructions are further configured to cause the at least one processor to:
receive images from the camera, and
display magnified versions of the received images.
